(19) United States
(12) Patent Application Publication
(10) Pub. No.: US 2024/0066939 A1
(43) Pub. Date: Feb. 29, 2024

(54) VEHICLE HEIGHT ADJUSTMENT DEVICE

(71) Applicant: ILJIN CO., LTD., Gyeongsangbuk-do (KR)

(72) Inventors: Se Woong JEONG, Ulsan (KR); Ig Jin KWON, Daegu (KR); Ki Ho KIM, Chungcheongbuk-do (KR)

(73) Assignee: ILJIN CO., LTD., Gyeongsangbuk-do (KR)

(21) Appl. No.: 18/270,708

(22) PCT Filed: Dec. 30, 2021
(86) PCT No.: PCT/KR2021/020311

§ 371 Date: Jun. 30, 2023

Related U.S. Application Data
(63) Continuation of application No. PCT/KR2021/020311, filed on Dec. 30, 2021.

(30) Foreign Application Priority Data
Dec. 30, 2020 (KR) 10-2020-0188571

(51) Int. Cl. B60G 17/015; F16H 25/20

(52) U.S. Cl. CPC B60G 17/0157; F16H 25/20; B60G 2202/12; B60G 2202/152; B60G 2202/42; B60G 2500/30

(57) ABSTRACT

A vehicle height adjusting apparatus for adjusting a height of a vehicle body of a vehicle is provided. The vehicle height adjusting apparatus includes an electric motor provided with a stator and a rotor and formed to have a structure in which a central portion thereof is penetrated; a screw nut fixed to the rotor of the electric motor and provided with a threaded portion on an inner peripheral surface thereof; a screw shaft inserted into and coupled to the inner peripheral surface of the screw nut and provided with a corresponding threaded portion having a shape corresponding to the threaded portion of the screw nut on an outer peripheral surface thereof; a guide portion configured to guide a relative movement between the screw nut and the screw shaft in a longitudinal direction.

### TECHNICAL FIELD

The present disclosure relates to a vehicle height adjusting apparatus for adjusting a height of a vehicle body of a vehicle, and more particularly, to a vehicle height adjusting apparatus which may be formed in a compact structure using a hollow motor.

### BACKGROUND ART

When a vehicle drives at high speed, the height of a vehicle body of the vehicle needs to be lowered in order to reduce air resistance. When the vehicle drives on a rough road surface, the height of a vehicle body needs to be raised in order to prevent damage to a lower portion of the vehicle body. To do this, a vehicle height adjusting apparatus for adjusting the height of the vehicle body may be mounted to a suspension device of the vehicle.

In the related art, a vehicle height adjusting apparatus has been mainly formed in a structure that is operated with a pneumatic pressure generated by power of an engine. However, such a pneumatic-type vehicle height adjusting apparatus may cause a decrease in fuel efficiency and output because it directly uses the power of the engine. In addition, in a case where the pneumatic pressure leaks due to a failure or breakage of parts, the adjustment of the height of the vehicle body may not be properly performed.

As a solution to this matter, in recent years, there has been proposed a electrically-powered vehicle height adjusting apparatus that adjusts the height of the vehicle body while moving the vehicle body up and down with an electric motor.

However, an electrically-powered vehicle height adjusting apparatus known in the related art has been designed to be driven by transmitting a driving force generated from an electric motor via a connection gear or the like. This complicates a structure of the vehicle height adjusting apparatus and makes it difficult to achieve the miniaturization and weight reduction of the vehicle height adjusting apparatus.

### DISCLOSURE

### Technical Problem

The present disclosure is to solve the above-mentioned matters, and the present disclosure is for the purpose of providing a vehicle height adjusting apparatus which may be formed in a compact structure using a hollow motor.

### Technical Solution

Representative configurations of the present disclosure to achieve the above matters are described below.

According to an example embodiment of the present disclosure, a vehicle height adjusting apparatus for adjusting a height of a vehicle body of a vehicle may be provided. The vehicle height adjusting apparatus according to an example embodiment of the present disclosure may comprise: an electric motor provided with a stator and a rotor and formed to have a structure in which a central portion thereof is penetrated; a screw nut fixed to the rotor of the electric motor and provided with a threaded portion on an inner peripheral surface thereof; a screw shaft inserted into and coupled to the inner peripheral surface of the screw nut and provided with a corresponding threaded portion having a shape corresponding to the threaded portion of the screw nut on an outer peripheral surface thereof; a guide portion configured to guide a relative movement between the screw nut and the screw shaft in a longitudinal direction. According to an example embodiment of the present disclosure, the guide portion may comprise: a guide slot having a recessed structure and formed to extend along a longitudinal direction of the screw shaft on the outer peripheral surface of the screw shaft; a rolling-body receiving groove having a recessed structure and formed in an inner peripheral surface of a housing of the electric motor or a member fixed to the housing; and a rolling body arranged between the guide slot and the rolling-body receiving groove.

In an aspect, the rolling body may be formed as a ball member having a spherical shape, and the guide slot and the rolling-body receiving groove may be formed to be depressed at predetermined radius of curvatures.

In an aspect, the predetermined radius of curvature of the guide slot and the predetermined radius of curvature of the rolling-body receiving groove may be set larger than a radius of the rolling body.

In an aspect, an elastic spring may be provided in an upper portion or a lower portion of the electric motor.

In an aspect, the elastic spring may be formed as a coil spring.

In an aspect, the elastic spring may be formed as an air spring.

In an aspect, a top mount assembly may be fixedly mounted to an upper portion of the screw shaft.

In an aspect, a shock absorber may be inserted into and mounted on a central portion of the screw shaft, and the screw shaft may be configured to adjust the height of the vehicle body while moving up and down in the longitudinal direction as the electric motor operates.

In an aspect, an upper spring seat may be provided on a lower portion of the electric motor, a lower spring seat may be provided on one side of the shock absorber, and the elastic spring may be provided between the upper spring seat and the lower spring seat.

In an aspect, the rolling-body receiving groove may be formed in an inner peripheral surface of the upper spring seat.

In an aspect, the screw shaft may be fixedly formed in a cylinder of the shock absorber.

In an aspect, the electric motor may be configured to adjust the height of the vehicle body while moving up and down in the longitudinal direction with respect to the screw shaft as the electric motor is operated.

In an aspect, a lower spring seat may be provided on an upper portion of the electric motor, an upper spring seat may be provided on a lower portion of the top mount assembly, and the elastic spring may be provided between the upper spring seat and the lower spring seat.

In an aspect, the electric motor may be fixedly mounted to a top mount assembly fixed to the vehicle body, a cylinder of the shock absorber may be fixedly mounted to a suspension device of the vehicle, the screw shaft may be fixedly formed in the cylinder of the shock absorber, and the electric motor is configured to adjust the height of the vehicle body while moving up and down in the longitudinal direction with respect to the screw shaft as the electric motor is operated.

In an aspect, the electric motor may be fixedly mounted to a suspension device of the vehicle, the screw shaft may be fixedly formed in a cylinder of the shock absorber, and the electric motor may be configured to adjust the height of the vehicle body while the screw shaft moves up and down in the longitudinal direction with respect to the electric motor as the electric motor is operated.

In addition, the vehicle height adjusting apparatus according to the present disclosure may further comprise other additional configurations without departing from the technical sprit of the present disclosure.

### Advantageous Effects

A vehicle height adjusting apparatus according to an example embodiment of the present disclosure is configured to be driven with a hollow motor. It is therefore possible to manufacture the vehicle height adjusting apparatus in a more compact structure.

Further, a vehicle height adjusting apparatus according to an example embodiment of the present disclosure is configured such that a rolling body is inserted into a guide slot formed on an outer peripheral surface of a screw shaft to guide a linear motion of a screw nut (and an electric motor to which the screw nut is coupled) and the screw shaft. Accordingly, even if the vehicle height adjusting apparatus is configured with the hollow motor, it is possible to adjust the height of the vehicle body while the screw nut (and the electric motor to which the screw nut is coupled) stably moves along the longitudinal direction of the screw shaft.

Further, a vehicle height adjusting apparatus according to an example embodiment of the present disclosure is configured such that a guide portion that assists a relative movement between a screw nut and a screw shaft in a longitudinal direction is provided using a rolling body that makes a rolling motion. This makes it possible to stably perform a linear motion between the screw nut (and the electric motor to which the screw nut is coupled) and the screw shaft in a longitudinal direction with less frictional force.

### DESCRIPTION OF DRAWINGS

FIG. 1 exemplarily illustrates an overall structure of a vehicle height adjusting apparatus according to an example embodiment of the present disclosure.

FIG. 2 exemplarily illustrates a cross-sectional structure of the vehicle height adjusting apparatus according to an example embodiment of the present disclosure.

FIG. 3 exemplarily illustrates a guide portion provided in the vehicle height adjusting apparatus according to an example embodiment of the present disclosure.

FIG. 4 exemplarily illustrates a structure of a vehicle height adjusting apparatus according to another example embodiment of the present disclosure.

FIG. 5 exemplarily illustrates a structure of a vehicle height adjusting apparatus according to yet another example embodiment of the present disclosure.

FIG. 6 exemplarily illustrates various modifications of a vehicle height adjusting apparatus according to an example embodiment of the present disclosure.

### EXPLANATION OF REFERENCE NUMERALS

100: Vehicle height adjusting apparatus
200: Electric motor
300: Screw nut
400: Screw shaft
500: Guide portion
510: Guide slot
520: Rolling-body receiving groove
530: Electric motor
600: Shock absorber
700: Elastic spring
710: Upper spring seat
720: Lower spring seat
800: Top mount assembly

### DETAILED DESCRIPTION

Example embodiments of the present disclosure described herein are exemplified for the purpose of explaining the technical spirit of the present disclosure. The scope of the claims according to the present disclosure is not limited to the example embodiments described below or to the detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure.

Unless the phrase or sentence clearly indicates otherwise, terms “comprising,” “including,” “having,” and the like used herein may be construed as open-ended terms encompassing the possibility of including other embodiments.

The singular form described herein may include the plural form unless the context clearly dictates otherwise, and this is equally applied to the singular form set forth in the claims.

Throughout the present specification, the expression “axial direction” or “longitudinal direction” means a direction along a central axis of a screw shaft, a screw nut, an electric motor, or the like, the expression “upper portion” means a direction in which a vehicle body is located with respect to a vehicle height adjusting apparatus, and the expression “lower portion” means a direction in which the ground is located with respect to the vehicle height adjusting apparatus.

Throughout the present specification, when a constituent element is referred to as being “positioned” or “formed” at one side of another constituent element, the constituent element may be in direct contact with the one side of another constituent element, or may be positioned or formed at another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding constituent elements. Further, in the following descriptions of the embodiments, duplicate descriptions of the same or corresponding constituent elements may be omitted. However, even though descriptions of a specific constituent element are omitted, such a constituent element is not intended to be excluded in a respective example embodiment.

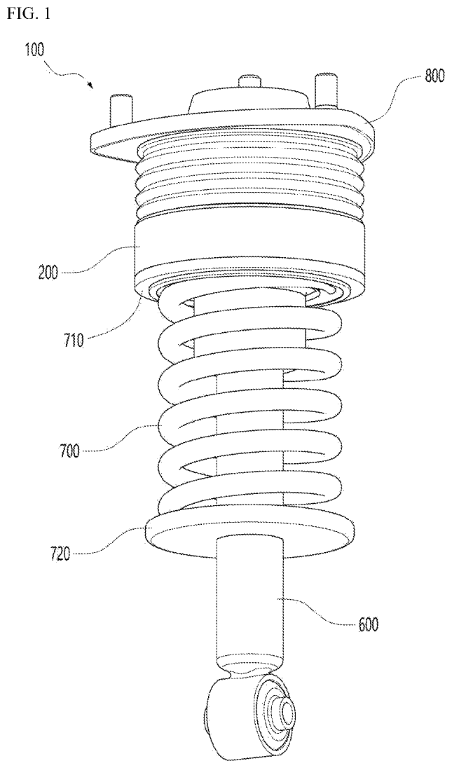

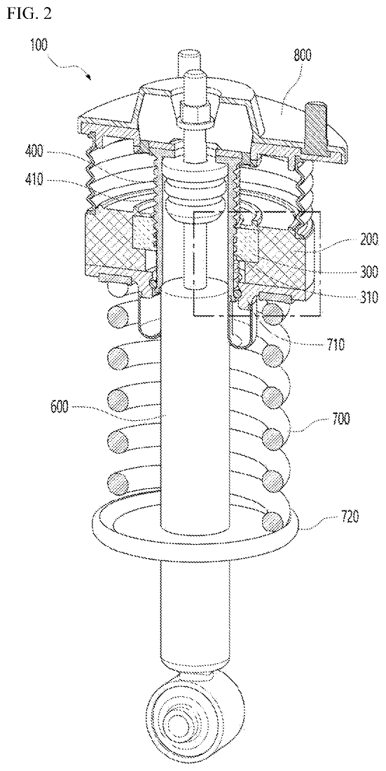

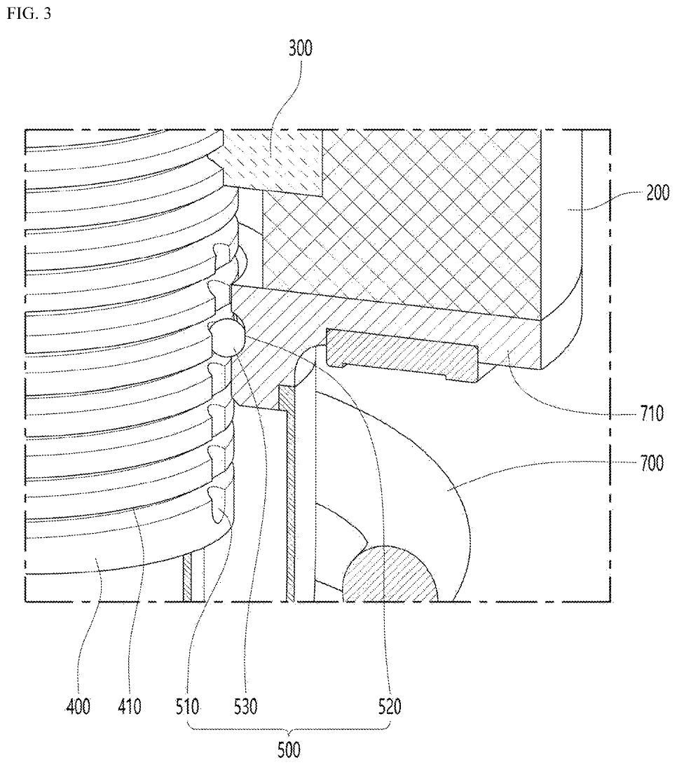

Referring to FIGS. 1 to 6, there is exemplarily illustrated a structure of a vehicle height adjusting apparatus according to an example embodiment of the present disclosure. As described later, the vehicle height adjusting apparatus according to an example embodiment of the present disclosure may be configured to be driven using a hollow electric motor, and may be configured such that a screw nut may stably move along a longitudinal direction of the screw shaft by forming a guide portion between the screw shaft and the screw nut.

According to an example embodiment of the present disclosure, a vehicle height adjusting apparatus 100 may be configured to comprise an electric motor 200, a screw nut 300 fixedly connected to a rotor of the electric motor 200, a screw shaft 400 coupled to the screw nut 300 so as to move relative to the screw nut 300, and the like.

According to an example embodiment of the present disclosure, the electric motor 200, which is a part that generates a driving force for operating the vehicle height adjusting apparatus 100, may be configured to comprise a stator and the rotor similarly to conventional electric motors.

According to an example embodiment of the present disclosure, the electric motor 200 may be configured as a hollow electric motor whose center portion is penetrated. For example, the electric motor 200 may be formed in a structure in which a center portion thereof is penetrated, and the screw nut 300 may be coupled and fixed to the penetrated center portion of the rotor.

According to an example embodiment of the present disclosure, the screw nut 300 may be fixed to the rotor of the electric motor 200 and configured to rotate together with the rotor as the operation of the electric motor 200.

According to an example embodiment of the present disclosure, the screw nut 300 may be formed in a structure in which a central portion thereof is penetrated. A threaded portion 310 may be provided on an inner peripheral surface of the penetrated central portion so as to be threadedly coupled to a corresponding threaded portion 410 of the screw shaft 400 described later.

According to an example embodiment of the present disclosure, the screw shaft 400 may be formed in a cylindrical structure extending in a longitudinal direction, and may be inserted into an inner peripheral surface of the screw nut 300 to be coupled to the screw nut 300.

According to an example embodiment of the present disclosure, an outer peripheral surface of the screw shaft 400 may be provided with the corresponding threaded portion 410 having a shape corresponding to the threaded portion 310 formed on the inner peripheral surface of the screw nut 300 so that the screw shaft 400 is threadedly coupled to the screw nut 300.

With this configuration, in the vehicle height adjusting apparatus 100 according to an example embodiment of the present disclosure, the screw nut 300 may move in the longitudinal direction along a central axis of the screw shaft 400 while rotating together with the rotor of the electric motor 200 as the electric motor 200 operates.

According to an example embodiment of the present disclosure, a guide portion 500 for guiding a relative movement between the screw nut 300 and the screw shaft 400 in the longitudinal direction may be provided on one side of the screw shaft 400.

According to an example embodiment of the present disclosure, the guide portion 500 may be configured to comprise a guide slot 510 formed in the outer peripheral surface of the screw shaft 400, a rolling-body receiving groove 520 provided to opposite the guide slot 510, a rolling body 530 interposed between the guide slot 510 and the rolling-body receiving groove 520, and the like.

According to an example embodiment of the present disclosure, the guide slot 510 may be formed in a recessed structure that is concave inward from the outer peripheral surface of the screw shaft 400. Further, the guide slot 510 may be formed in a curved structure having a radius of curvature of a size corresponding to a radius of the rolling body 530, and may be formed to extend along the longitudinal direction of the screw shaft 400.

According to an example embodiment of the present disclosure, the rolling-body receiving groove 520 may be formed in a recess structure that is concave radially outward from an inner peripheral surface of a housing of the electric motor 200 or a member fixed to the housing, and may be formed in a curved structure having a radius of curvature of the size corresponding to the radius of the rolling body 530.

For example, in the case of the example embodiment illustrated in FIGS. 1 to 3, the rolling-body receiving groove 520 is provided on an inner peripheral surface of an upper spring seat 710 fixed to the housing of the electric motor 200.

According to an example embodiment of the present disclosure, the rolling body 530 is a member that makes a rolling motion between the guide slot 510 and the rolling-body receiving groove 520. The rolling body 530 may be arranged between the guide slot 510 and the rolling-body receiving groove 520 in a state in which one side thereof is inserted into the guide slot 510 and another side is inserted into the rolling-body receiving groove 520. For example, according to an example embodiment of the present disclosure, the rolling body 530 may be formed as a ball member having a spherical shape, as illustrated in the drawings.

According to an example embodiment of the present disclosure, one or more guide portions 500 may be provided along a circumferential direction of the screw shaft 400. For example, in the case of the example embodiment illustrated in the drawings, the vehicle height adjusting apparatus 100 is configured such that four guide portions 500 are provided at intervals of 90 degrees along the circumferential direction of the screw shaft 400.

As described above, the vehicle height adjusting apparatus 100 according to an example embodiment of the present disclosure is configured to assist a relative movement between the screw shaft 400 and the electric motor 200 in the longitudinal direction using the guide portion 500. Thus, the electric motor 200 may stably move in the longitudinal direction without rotating relative to the screw shaft 400 when the electric motor 200 operates.

Further, in the vehicle height adjusting apparatus 100 according to an example embodiment of the present disclosure, the guide portion 500 is formed with the rolling body 530 and receiving grooves (the guide slot 510 and the rolling-body receiving groove 520) of receiving the rolling body 530. Thus, the rolling body 530 may guide the longitudinal movement of the electric motor 200 and the screw nut 300 coupled to the electric motor 200 while making the rolling motion. This assists the movement of the electric motor 200 and the screw nut 300 coupled to the electric motor 200 relative to the screw shaft 400 in the longitudinal direction with less frictional resistance.

According to an example embodiment of the present disclosure, the guide portion 500 may be formed to have a structure and size in which the rolling body 530 may move merely in a direction in which the guide slot 510 is formed.

For example, the guide portion 500 may be formed such that the rolling body 530 has a diameter that the rolling body 530 is not inserted into a space between threads of the corresponding threaded portion 410 formed in the outer peripheral surface of the screw shaft 400. Further, the guide portion 500 may be formed such that the guide slot 510 formed in the outer peripheral surface of the screw shaft 400 and the rolling-body receiving groove 520 formed in the inner peripheral surface of the housing of the electric motor 200 or the member fixed to the housing has a radius of curvature, which corresponds to or is slightly larger than the radius of the rolling body 530, so as to receive the rolling body 530.

According to an example embodiment of the present disclosure, the vehicle height adjusting apparatus 100 described above may be configured to be coupled to a shock absorber 600 provided in a suspension device of the vehicle. For example, in the example embodiment illustrated in FIGS. 1 to 3, the shock absorber 600 may be configured to be inserted into the central portion of the screw shaft 400 and coupled to the screw shaft 400.

According to an example embodiment of the present disclosure, an elastic spring 700 may be provided on an upper or lower portion of the electric motor 200 to generate an elastic force. For example, in the example embodiment illustrated in FIGS. 1 to 3, the upper spring seat 710 is provided on a lower end portion of the electric motor 200, a lower spring seat 720 is provided on a cylinder of the shock absorber 600, and the elastic spring 700 of a coil spring structure is arranged between the upper spring seat 710 and the lower spring seat 720.

According to an example embodiment of the present disclosure, the screw shaft 400 may be configured to be fixedly mounted to a top mount assembly 800 fixed to the vehicle body. Further, the top mount assembly 800 may be configured to be coupled to a piston member of the shock absorber 600.

For example, in the case of the example embodiment illustrated in FIGS. 1 to 3, the top mount assembly 800 is fixedly mounted to the upper portion of the screw shaft 400, and an upper end portion of the cylinder of the shock absorber 600 is fixedly mounted to the top mount assembly 800.

In the vehicle height adjusting apparatus 100 configured as above according to an example embodiment of the present disclosure, when the electric motor 200 is driven, the rotation of the rotor enables a relative movement between the screw nut 300 fixed to the rotor and the screw shaft 400 in the longitudinal direction. As a result, the screw shaft 400 is moved up and down in the longitudinal direction, and the top mount assembly 800 coupled to the upper portion of the screw shaft 400 and the vehicle body fixed to the top mount assembly 800 are moved up and down, which makes it possible to adjust the height of the vehicle body.

Further, the vehicle height adjusting apparatus 100 according to an example embodiment of the present disclosure may be modified in various structures as long as it is configured to be driven using the hollow motor 200, the screw nut 300 fixed to the rotor moves relative to the screw shaft 400 in the longitudinal direction with the operation of the electric motor 200, and the guide portion 500 for assisting the relative movement between the screw nut 300 and the screw shaft 400 in the longitudinal direction is provided on one side of the screw shaft 400.

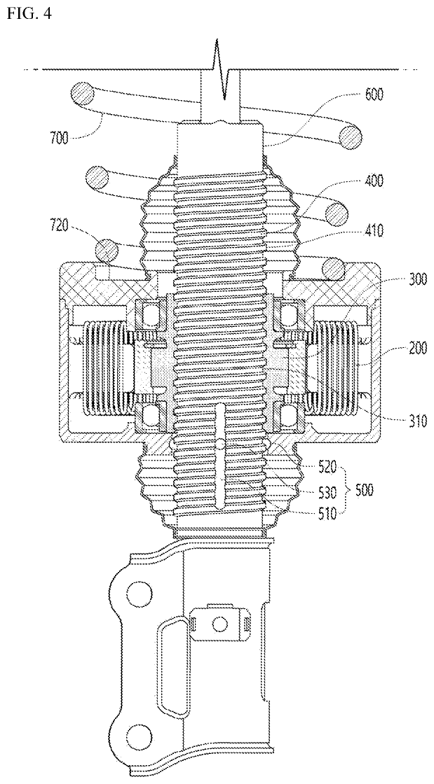

For example, referring to FIGS. 4 to 6, a vehicle height adjusting apparatus 100 according to other example embodiments of the present disclosure are exemplarily illustrated.

First, referring to FIG. 4, an example embodiment is exemplarily illustrated in which the electric motor 200 is configured to adjust the height of the vehicle body while moving up and down instead of the screw shaft 400.

Specifically, the vehicle height adjusting apparatus 100 of the example embodiment illustrated in FIG. 4 may be configured to comprise an electric motor 200, a screw nut 300, and a screw shaft 400 similarly to the vehicle height adjusting apparatus of the above-described example embodiment. Further, in the vehicle height adjusting apparatus 100 of the example embodiment illustrated in FIG. 4, a guide portion 500 for guiding the relative movement between the screw nut 300 and the screw shaft 400 in the longitudinal direction may be provided on one side of the screw shaft 400.

However, the vehicle height adjusting apparatus 100 of the example embodiment illustrated in FIG. 4 differs from the above-described example embodiment in that the screw shaft 400 is fixedly provided to the cylinder of the shock absorber 600 (for example, in the example embodiment illustrated in FIG. 4, the corresponding threaded portion 410 to be coupled to the threaded portion 310 of the screw nut 300 is directly formed in the outer peripheral surface of the cylinder of the shock absorber 600, and the cylinder of the shock absorber 600 also performs the function of the screw shaft 400), and the elastic spring 700 is positioned on the upper portion of the electric motor 200 (for example, in the example embodiment illustrated in FIG. 4, the upper surface of the electric motor 200 serves as the lower spring seat 720, and the elastic spring 700 is interposed between the lower spring seat 720 and an upper spring seat (not illustrated) provided a lower portion of the top mounted assembly).

Other configurations other than the above are different in detail shapes from that in the above-described example embodiment, but there may be implemented in substantially the same or similar manner as that in the example embodiment described above, and therefore more detailed descriptions thereof will be omitted.

As described above, the vehicle height adjusting apparatus 100 of the example embodiment illustrated in FIG. 4 is configured such that the screw shaft 400 is formed integrally with the cylinder of the shock absorber 600 to be fixed to the suspension device of the vehicle, and the screw nut 300 and the electric motor 200 coupled to the screw nut 300 are mounted on the outer peripheral surface of the screw shaft 400. Thus, when the electric motor 200 is operated, the electric motor 200 moves up and down relative to the screw shaft 400 in the longitudinal direction to vertically adjust the height of the vehicle body via the elastic spring 700 located on the upper portion of the electric motor 200.

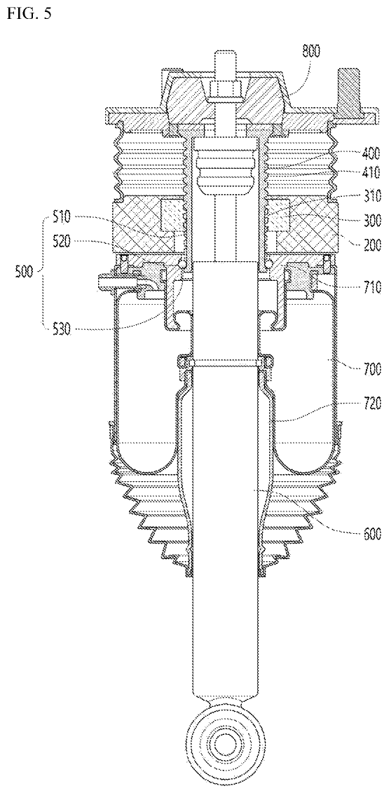

Referring to FIG. 5, an example embodiment in which the elastic spring 700 provided on one side of the electric motor 200 is formed as an air spring instead of the coil spring is exemplarily illustrated.

Specifically, a vehicle height adjusting apparatus 100 of the example embodiment illustrated in FIG. 5 may be formed in the same or similar structure as the vehicle height adjusting apparatus 100 illustrated in FIGS. 1 to 3 as a whole, but is different from the example embodiment illustrated in FIGS. 1 to 3 in that the elastic spring 700 is formed as an air spring instead of the coil spring.

A specific structure and operation mechanism of the vehicle height adjusting apparatus 100 according to the example embodiment illustrated in FIG. 5 may be implemented substantially the same as the example embodiment illustrated in FIGS. 1 to 3, and thus detailed descriptions thereof will be omitted.

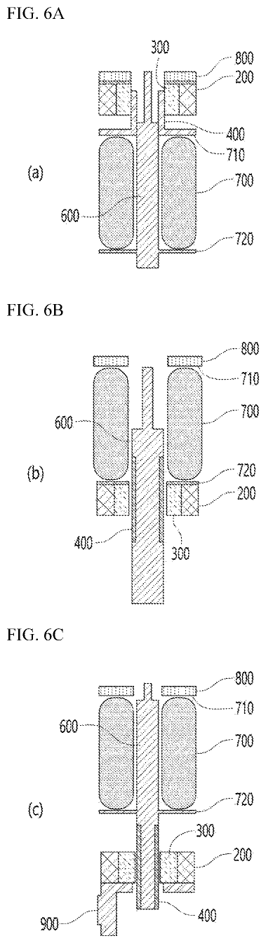

Referring to FIG. 6, various modifications of the vehicle height adjusting apparatus 100 according to an example embodiment of the present disclosure are conceptually illustrated. For reference, in the modifications illustrated in FIG. 6, the guide portion 500 is omitted for the sake of simplification in illustration. However, the guide portion 500 may be provided in the vehicle height adjusting apparatus 100 illustrated in FIG. 6 in the same manner as in the example embodiment described above.

Specifically, the vehicle height adjusting apparatus 100 illustrated in FIG. 6A is configured such that the electric motor 200 is fixedly mounted to the top mount assembly 800, and the screw shaft 400 is fixedly provided on the cylinder of the shock absorber 600. Thus, when the electric motor 200 is operated, the electric motor 200 moves in the longitudinal direction relative to the screw shaft 400 to adjust the height of the vehicle body.

Further, the vehicle height adjusting apparatus 100 illustrated in FIG. 6B has substantially the same structure as the vehicle height adjusting apparatus 100 of the example embodiment illustrated in FIG. 4, but is different from the vehicle height adjusting apparatus 100 of the example embodiment illustrated in FIG. 4 in that the elastic spring 700 positioned on the upper portion of the electric motor 200 is formed as an air spring instead of the coil spring.

Further, the vehicle height adjusting apparatus 100 illustrated in FIG. 6C is configured such that the electric motor 200 is fixedly mounted to a suspension device 900 (a knuckle, a lower arm, or the like of the suspension device), and the screw shaft 400 is fixedly provided on the shock absorber 600. Thus, when the electric motor 200 is operated, the screw shaft 400 and the shock absorber 600 vertically move in the longitudinal direction to adjust the height of the vehicle body.

Although the present disclosure has been described above in terms of specific items such as detailed constituent elements as well as the limited example embodiments, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be said to belong to the scope and spirit of the present disclosure.

1. A vehicle height adjusting apparatus for adjusting a height of a vehicle body of a vehicle, the vehicle height adjusting apparatus comprising:
an electric motor provided with a stator and a rotor and formed to have a structure in which a central portion thereof is penetrated;
a screw nut fixed to the rotor of the electric motor and provided with a threaded portion on an inner peripheral surface thereof;
a screw shaft inserted into and coupled to the inner peripheral surface of the screw nut and provided with a corresponding threaded portion having a shape corresponding to the threaded portion of the screw nut on an outer peripheral surface thereof;
a guide portion configured to guide a relative movement between the screw nut and the screw shaft in a longitudinal direction,
wherein the guide portion comprises:
a guide slot having a recessed structure and formed to extend along a longitudinal direction of the screw shaft on the outer peripheral surface of the screw shaft;
a rolling-body receiving groove having a recessed structure and formed in an inner peripheral surface of a housing of the electric motor or a member fixed to the housing; and
a rolling body arranged between the guide slot and the rolling-body receiving groove.

2. The vehicle height adjusting apparatus of claim 1, wherein the rolling body is formed as a ball member having a spherical shape, and
the guide slot and the rolling-body receiving groove are formed to be depressed at predetermined radius of curvatures.

3. The vehicle height adjusting apparatus of claim 2, wherein the predetermined radius of curvature of the guide slot and the predetermined radius of curvature of the rolling-body receiving groove are set larger than a radius of the rolling body.

4. The vehicle height adjusting apparatus of claim 1, wherein an elastic spring is provided in an upper portion or a lower portion of the electric motor.

5. The vehicle height adjusting apparatus of claim 4, wherein the elastic spring is formed as a coil spring.

6. The vehicle height adjusting apparatus of claim 4, wherein the elastic spring is formed as an air spring.

7. The vehicle height adjusting apparatus of claim 1, wherein a top mount assembly is fixedly mounted to an upper portion of the screw shaft.

8. The vehicle height adjusting apparatus of claim 7, wherein a shock absorber is inserted into and mounted on a central portion of the screw shaft, and
the screw shaft is configured to adjust the height of the vehicle body while moving up and down in the longitudinal direction as the electric motor operates.

9. The vehicle height adjusting apparatus of claim 8, wherein an upper spring seat is provided on a lower portion of the electric motor,
a lower spring seat is provided on one side of the shock absorber, and
an elastic spring is provided between the upper spring seat and the lower spring seat.

10. The vehicle height adjusting apparatus of claim 9, wherein the rolling-body receiving groove is formed in an inner peripheral surface of the upper spring seat.

11. The vehicle height adjusting apparatus of claim 7, wherein the screw shaft is fixedly formed in a cylinder of a shock absorber.

12. The vehicle height adjusting apparatus of claim 11, wherein, the electric motor is configured to adjust the height of the vehicle body while moving up and down in the longitudinal direction with respect to the screw shaft as the electric motor is operated.

13. The vehicle height adjusting apparatus of claim 12, wherein a lower spring seat is provided on an upper portion of the electric motor,
an upper spring seat is provided on a lower portion of the top mount assembly, and
an elastic spring is provided between the upper spring seat and the lower spring seat.

14. The vehicle height adjusting apparatus of claim 1, wherein the electric motor is fixedly mounted to a top mount assembly fixed to the vehicle body,
a cylinder of a shock absorber is fixedly mounted to a suspension device of the vehicle,
the screw shaft is fixedly formed in the cylinder of the shock absorber, and
the electric motor is configured to adjust the height of the vehicle body while moving up and down in the longitudinal direction with respect to the screw shaft as the electric motor is operated.

15. The vehicle height adjusting apparatus of claim 1, wherein the electric motor is fixedly mounted to a suspension device of the vehicle,
the screw shaft is fixedly formed in a cylinder of a shock absorber, and
the electric motor is configured to adjust the height of the vehicle body while the screw shaft moves up and down in the longitudinal direction with respect to the electric motor when the electric motor is operated.
